(19) United States
(12) Patent Application Publication
(10) Pub. No.: US 2025/0063126 A1
(43) Pub. Date: Feb. 20, 2025

(54) INTERACTIVE PHOTO BOOTH SYSTEM THAT IS WIRELESSLY PAIRED WITH A PRIMARY MOBILE DEVICE AND RELATED METHODS

(71) Applicants: Mark Lizada, Las Vegas, NV (US); Rey Borja, Las Vegas, NV (US); Kim Banson, Las Vegas, NV (US); John Cayabyab, Las Vegas, NV (US)

(72) Inventors: Mark Lizada, Las Vegas, NV (US); Rey Borja, Las Vegas, NV (US); Kim Banson, Las Vegas, NV (US); John Cayabyab, Las Vegas, NV (US)

(21) Appl. No.: 18/233,570

(22) Filed: Aug. 14, 2023

(51) Int. Cl. H04N 1/00; H04N 5/272

(52) U.S. Cl. CPC H04N 1/00973; H04N 1/00164; H04N 1/00188; H04N 5/2621; H04N 1/0014; H04N 2101/00; H04N 2201/0084; H04N 2201/0096

(57) ABSTRACT

Disclosed are a method and/or a system of an interactive photo booth that is wirelessly paired with a primary mobile device. In one embodiment, a photo booth system includes a transparent touch display, a set of walls on a rear side of the transparent touch display to form a rectangular cavity to project an image on a front side of the transparent touch display. A photo booth application executes on a different operating system language than that of the transparent touch display, and automatically establishes a bidirectional communication channel with the transparent touch display. The image is a two dimensional image that is perceptible to a human eye as being a three dimensional projection encapsulated within the rectangular cavity. A wireless communications circuitry automatically loads a thin client application operating on a first operating system language whenever the transparent touch display is powered.

### FIELD OF TECHNOLOGY

This disclosure relates generally to the field of computing systems, and more specifically to a method and system of an interactive photo booth that is wirelessly paired with a primary mobile device.

### BACKGROUND

A photo booth may enable individuals or groups to take photos of themselves at events, parties, or public places. Users might want to get input from their friends when customizing their photos. However, a display of the photo booth on which the user can customize screens may be small and limited in its options, making it difficult to customize and share. Therefore, the photo booth experience may not capture the input of friends and family near a photo booth prior to a photo being printed and/or shared. In addition, the photo booth may be a small, self-contained setup. People may not see the photo booth and may simply ignore it. Also, wires in a photo booth set up might create tripping hazards. Finally, there may be technical problems that prevent the photo booth from reliably operating when in a mixed operating system environment. These issues can disrupt the user experience and lead to frustration among event attendees.

### SUMMARY

Disclosed are a method and/or a system of an interactive photo booth that is wirelessly paired with a primary mobile device.

In one aspect, a photo booth system includes a transparent touch display and a set of walls on a rear side of the transparent touch display to form a rectangular cavity to project an image on a front side of the transparent touch display. The image is a two dimensional image that is perceptible to a human eye as being a three dimensional projection encapsulated within the rectangular cavity. A wireless communications circuitry is associated with a processor and a memory of the transparent touch display. The memory automatically loads a thin client application operating on a first operating system language whenever the transparent touch display is powered. The wireless communication circuitry authenticates onto a local area network. A mobile device having a front facing camera operates a different operating system language than the first operating system language. A tripod is used to affix the mobile device. The image is captured in a field of view area using the mobile device. The image is a portrait of a human subject in the field of view area. A photo booth application executes on the different operating system language of the mobile device, and automatically establishes a bidirectional communication channel with the transparent touch display.

The transparent touch display may wirelessly mirror a view displayed on the mobile device as the image. The transparent touch display may serve as a touchscreen to serve as a controller for an operation of the photo booth application on the mobile device. The photo booth application on the mobile device may automatically affix a custom photo frame overlay image on the image. The photo booth application on the mobile device may automatically apply a visual filter effect on the image. A user of the transparent touch display may be permitted to select photo frames and/or visual filters to apply to the image. The photo frames and/or visual filters may be automatically viewable on the transparent touch display. The transparent touch display may be a lifesize display that is at least 72 inches tall. A printing device May automatically print a copy of the image when a print operation is initiated on the photo booth application using the transparent touch screen display. The user may be able to enter an email address and/or a phone number using the transparent touch display to which the image is communicated.

In another aspect, a photography system includes a photo booth having a transparent touch display that projects an image, a local area network, and a mobile device to capture the image from a human subject. The transparent touch display wirelessly serves as a controller of a photo booth application executing on the mobile device. The transparent touch display and the photo booth application are automatically wirelessly paired with each other through the local area network using a User Datagram Protocol (UDP) and/or a Transmission Control Protocol/Internet Protocol (TCP/IP) protocol. Three ports are used in this aspect, despite the photo booth and the mobile device having different operating systems. The first port is used to mirror the information on a screen of the mobile device onto the transparent touch display, and other two ports are used for bidirectional communication channels between the transparent touch display of the photo booth and the photo booth application of the mobile device.

In yet another aspect, a method includes projecting an image on a front side of a lifesize display, automatically loading a thin client application operating on a first operating system language whenever the lifesize display is powered, authenticating the lifesize display onto a local area network, detecting that a photo booth application is open on a mobile device communicatively coupled with the lifesize display through the local area network, and automatically establishing a bidirectional communication channel between the lifesize display and the photo booth application. The mobile device operates using a different operating system language than the lifesize display. The image is a two dimensional image that is perceptible to a human eye as being a three dimensional projection encapsulated within the rectangular cavity. The photo booth application takes an image using a camera of the mobile device. The lifesize display simultaneously displays the image while operating as a touchscreen controller of the photo booth application on the mobile device.

The methods and systems disclosed herein may be implemented in any means for achieving various aspects, and may be executed in various forms, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is an photo booth system illustrating a method of taking an interactivephotograph at a live event through a wirelessly coupled transparent touchscreen display with a mobile device, according to one embodiment.

FIG. 2 is an operational view of the photo booth system of FIG. 1 illustrating the transparent touch display to serve as a touchscreen to serve as a controller for an operation of the photo booth application on the mobile device, according to one embodiment.

FIG. 3 is a conceptual view of the photo booth system of FIG. 1 illustrating an automatic printing of a copy of the image when a print operation is initiated on the photo booth application by a user using the transparent touch screen display, according to one embodiment.

FIG. 4 is a process flow detailing the operations involved in taking an interactivephotograph at a live event through a wirelessly coupled photobooth touchscreen display with a mobile device of FIG. 1, according to one embodiment.

FIG. 5 is a diagrammatic system view of a data processing system in which any of the embodiments disclosed herein may be performed, according to one embodiment.

Other features of the present embodiments will be apparent from the accompanying drawings and from the detailed description that follows.

### DETAILED DESCRIPTION

Example embodiments, as described below, may be used to provide a method and/or a system of an interactive photo booth that is wirelessly paired with a primary mobile device.

In one embodiment, a photo booth system 150 includes a transparent touch display 102 and a set of walls on a rear side of the transparent touch display 102 to form a rectangular cavity 104 to project an image 106 on a front side of the transparent touch display 102. The image 106 is a two dimensional image that is perceptible to a human eye as being a three dimensional projection encapsulated within the rectangular cavity 104. A wireless communications circuitry 108 is associated with a processor 130 and a memory 132 of the transparent touch display 102. The memory 132 automatically loads a thin client application 112 operating on a first operating system 110 language (e.g., Google® Android® operating system) whenever the transparent touch display 102 is powered. The wireless communication circuitry 108 authenticates onto a local area network 114. A mobile device 116 having a front facing camera 118 operates a different operating system 120 language (e.g., Apple® iOS® operating system) than the first operating system 110 language. A tripod 122 is used to affix the mobile device 116. The image 106 is captured in a field of view 124 area using the mobile device 116. The image 106 is a portrait of a human subject 126 in the field of view 124 area. A photo booth application 128 executes on the different operating system 120 language of the mobile device 116, and automatically establishes a bidirectional communication channel with the transparent touch display 102.

The transparent touch display 102 may wirelessly mirror a view 202 displayed on the mobile device 116 as the image 106. The transparent touch display 102 may serve as a touchscreen to serve as a controller 204 for an operation of the photo booth application 128 on the mobile device 116. The photo booth application 128 on the mobile device 116 may automatically affix a custom photo frame overlay image 208 on the image 106. The photo booth application 128 on the mobile device 116 may automatically apply a visual filter effect 212 on the image 106. A user 314 of the transparent touch display 102 may be permitted to select photo frames and/or visual filters to apply to the image 106. The photo frames (e.g., using the set of photo frames 306) and/or visual filters (e.g., using the set of visual filters 304) may be automatically viewable on the transparent touch display 102. The transparent touch display 102 may be a lifesize display 302 that is at least 72 inches tall. A printing device 308 may automatically print a copy of the image 106 when a print operation (e.g., operation 206) is initiated on the photo booth application 128 using the transparent touch screen display 102. The user may be able to enter an email address 310 and/or a phone number 312 using the transparent touch display 102 to which the image 106 is communicated.

In another embodiment, a photography system includes a photo booth having a transparent touch display 102 that projects an image 106, a local area network 114, and a mobile device 116 to capture the image 106 from a human subject 126. The transparent touch display 102 wirelessly serves as a controller 204 of a photo booth application 128 executing on the mobile device 116. The transparent touch display 102 and the photo booth application 128 are automatically wirelessly paired with each other through the local area network 114 using a User Datagram Protocol (UDP) and/or a Transmission Control Protocol/Internet Protocol (TCP/IP) protocol. Three ports are used in this embodiment, despite the photo booth and the mobile device 116 having different operating systems. The first port is used to mirror the information on a screen of the mobile device 116 onto the transparent touch display 102, and other two ports are used for bidirectional communication channels between the transparent touch display 102 of the photo booth and the photo booth application 128 of the mobile device 116.

In yet another embodiment, a method includes projecting an image 106 on a front side of a lifesize display, automatically loading a thin client application 112 operating on a first operating system 110 language whenever the lifesize display 302 is powered, authenticating the lifesize display 302 onto a local area network 114, detecting that a photo booth application 128 is open on a mobile device 116 communicatively coupled with the lifesize display 302 through the local area network 114, and automatically establishing a bidirectional communication channel between the lifesize display 302 and the photo booth application 128. The mobile device 116 operates using a different operating system 120 language than the lifesize display 302. The image 106 is a two dimensional image 106 that is perceptible to a human eye as being a three dimensional projection encapsulated within the rectangular cavity 104. The photo booth application 128 takes an image 106 using a camera of the mobile device 116. The lifesize display 302 simultaneously displays the image 106 while operating as a touchscreen controller 204 of the photo booth application 128 on the mobile device 116.

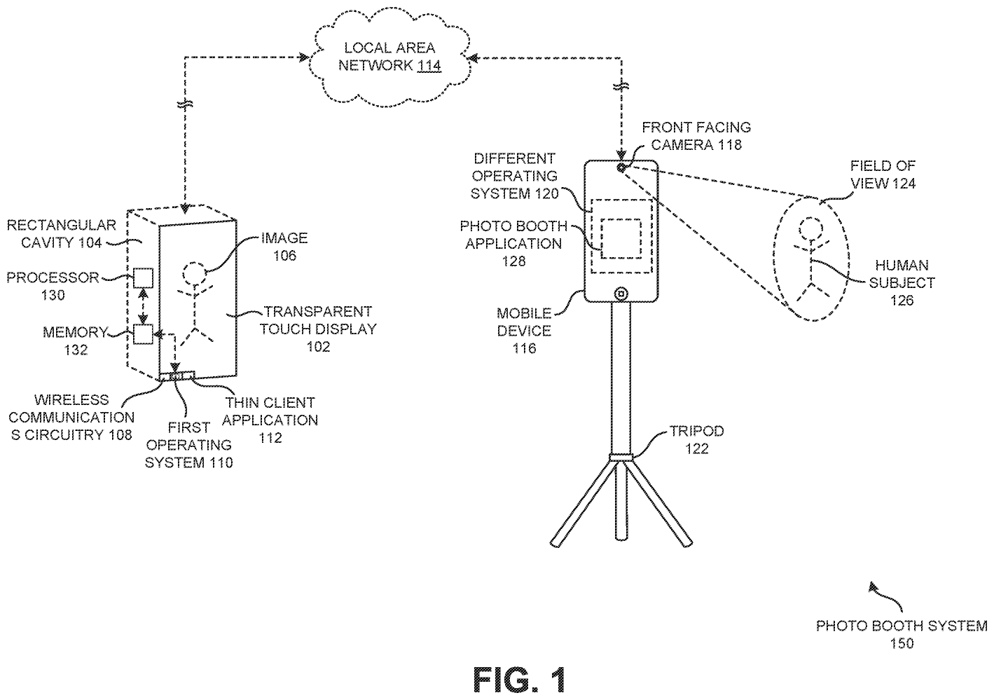

FIG. 1 is an photo booth system 150 illustrating a method of taking an interactive photograph at an event through a wirelessly coupled photobooth touchscreen display 102 with a mobile device 116, according to one embodiment. Particularly, FIG. 1 illustrates a transparent touch display 102, a rectangular cavity 104, an image 106, a wireless communication circuitry 108, a first operating system 110, a thin client application 112, a local are network 114, a mobile device 116, a front facing camera 118, a different operating system 120, a tripod 122, a field of view 124, a human subject 126, a photobooth application 128, a processor 130, and a memory 132, according to one embodiment.

The transparent touch display 102 may be an electronic display screen that allows a user 314 to see what is shown on the screen while still being able to see through it. The transparent touch display 102 may be an assembly of both an input (e.g., a touch panel) and output (e.g., a display) device. The user 314 may interact with the photo booth system 150 by using hand gestures and fingertip movements to tap pictures, move elements, and/or type words on the transparent touch display 102 of the photo booth system 150. The transparent touch display 102 may be pressure-sensitive and can be used and/or manipulated using fingers and/or a stylus in order to interact with the photo booth system 150, according to one embodiment.

The transparent touch screen display 102 may combine the functionality of a touchscreen with the ability to see through the display. It may utilize transparent conductive materials and sensors to detect touch inputs while maintaining visibility of the content displayed behind it. In the context of a photo booth system 150, this feature may enable the user 314 to select options (e.g., using operation 206), apply filters (e.g., using visual filter effect 212 from the set of visual filters 304), and/or navigate through the system's interface by directly interacting with the transparent display, according to one embodiment.

According to one embodiment, the transparent touch display 102 may be a display technology that uses light-emitting diodes (LEDs) to produce an image 106. The light emitted from the LEDs may be projected onto a transparent surface of the transparent touch display 102 and this transparency may allow visibility from both sides of the screen, according to one embodiment.

The rectangular cavity 104 may be a quadrilateral chamber created at the posterior portion of the transparent touch display 102 by a set of walls for the user 314 to take live photographs and/or videos inside the cavity that is displayed on the transparent touch display 102 in real time, according to one embodiment.

The image 106 may be a visual representation of the user 314 and/or a person who uses the photo booth system 150 to take live photographs and/or videos inside the rectangular cavity 104 that is displayed on the transparent touch display 102 in realtime. The image 106 displayed on the transparent touch display 102 may be a two dimensional image, however, it may be manifested as a three dimensional projection encapsulated within the rectangular cavity by a human eye, according to one embodiment.

The wireless communication circuitry 108 may be a system of circuits performing a particular function of transmission of voice and/or data in the photo booth system 150 without cable and/or wires. In place of a physical connection, the data may travel through electromagnetic signals broadcast from transparent touch display 102 of the photo booth system 150 to intermediate and/or end-user device (e.g., mobile device 116). The wireless communication circuitry 108 of the transparent touch display 102 may automatically authenticate onto the local area network 114, according to one embodiment.

The first operating system 110 may be a primary program that, after being initially loaded into the transparent touch display 102 by a boot program, manages all of the other application programs in the transparent touch display 102 of the photo booth system 150, according to one embodiment.

The thin client application 112 may be a kind of software installed in a computer system (e.g., transparent touch display 102) used to run applications (e.g., photo booth application 128) where most of the actual processing is done on a remote server (e.g., mobile device 116) linked over a network (e.g., local area network 114). The thin client application 112 may be a kind of software that performs specific function of capturing live photographs (e.g., image 106) and/or videos inside the rectangular cavity 104 that is displayed on the transparent touch display 102 in realtime for the end user 314 by interacting directly with the application programs (e.g., photo booth application 128). The thin client application 112 may be used to display the results in a way that is as close as possible to what one might see when running the program locally. The thin client application 112 may work on first operating system 110 of the transparent touch display 102 locally and carry flash memory. All applications and data for thin client application 112 may be stored in the central server and allows local printing (e.g., printing device 308), device support, web browsing, and/or processing network computing of the photo booth system 150, according to one embodiment.

The local are network 114 may be a collection of devices (e.g., transparent touch display 102, mobile device 116) connected together in one physical location, such as a building, office, and/or home. The local are network 114 may be a network contained within a small geographic area, usually within the same building and/or location, according to one embodiment.

The mobile device 116 may be a small hand-held device that has a display screen with touch input and/or a QWERTY keyboard and may provide users with telephony capabilities. The mobile device 116 may be communicatively coupled to the transparent touch display 102 through the local area network 114, according to one embodiment.

The front facing camera 118 may be a camera situated at the forepart of the mobile phone (e.g., mobile device 116) facing towards to the observer and/or the user 314. The front facing camera 118 may be used to take a selfie by the user 314 that may be concurrently displayed on the transparent touch display 102 of the photo booth system 150, according to one embodiment.

The different operating system 120 may be a distinct program other than the first operating system 110 that, after being initially loaded into the mobile device 116 by a boot program, manages all of the other application programs in the mobile device 116. The tripod 122 may be a three-legged stand and/or a mount used to steady a mobile device 116 in order to take a selfie and/or a video using the front facing camera 118 of the mobile device 116, according to one embodiment.

The field of view 124 may be the extent of the observable world and/or the maximum area that the front facing camera 118 of the mobile device 116 can capture. The human subject 126 may be a person who becomes a participant in the event captured by the front facing camera 118 of the mobile device 116 to be displayed on the transparent touch display 102 of the photo booth system 128, according to one embodiment.

The photobooth application 128 may be software program installed in the mobile device 116 that automatically establishes a bidirectional communication channel with the transparent touch display 102 of the photo booth system 150. The photo booth application 128 may execute on a different operating system language of the mobile device 116. Once installed, the photo booth application 128 may allow the user 314 to perform a specific function of capturing live photographs and/or videos using the front facing camera 118 that is displayed on the transparent touch display 102 as the image 106. The end user 314 may interact directly with the application programs using the mobile device 116. The two dimensional image 106 captured using the front facing camera 118 displayed on the transparent touch display 102 may appear as being a three dimensional projection inside the rectangular cavity 104 to an observer and/or a user 116, according to one embodiment.

The processor 130 may be a logic circuitry that responds to and processes the basic instructions that drive the transparent touch display 102 of the photo booth system 150. The memory 132 may be a storage space in the transparent touch display 102 that stores data while the transparent touch display 102 of the photo booth system 150 runs. The memory 132 may automatically load the thin client application 112 operating on the first operating system 110 language whenever the transparent touch display 102 is powered on, according to one embodiment.

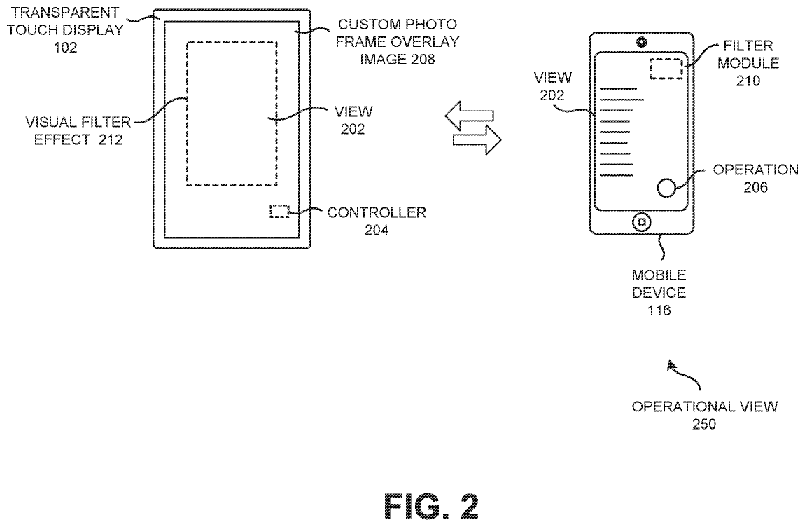

FIG. 2 is an operational view 250 of the photo booth system 150 of FIG. 1 illustrating the transparent touch display 102 to serve as a touchscreen to serve as a controller 204 for an operation 206 of the photo booth application 128 on the mobile device 116, according to one embodiment. Particularly, FIG. 2 builds on FIG. 1, and further adds, a view 202, a controller 204, an operation 206, a custom photo frame overlay image 208, a filter module 210, and a visual filter effect 212, according to one embodiment.

The view 202 may be an identical depiction of a visual (e.g., view 202) exhibited on the mobile device 116 getting presented in the transparent touch display 102 as an image 106. The photo booth application 128 of the mobile device 116 may enable the transparent touch display 102 to wirelessly mirror a view 202 displayed on the mobile device 116 as the image 106, according to one embodiment.

The controller 204 may be a hardware device and/or a software program that manages and/or directs the flow of data between the transparent touch display 102 and the mobile device 116. The operation 206 may be an act of running and/or utilitzing the photo booth application 128 on the mobile device 116 to navigate and/or interact with the transparent touch display 102 as a touchscreen, according to one embodiment.

The custom photo frame overlay image 208 may be a process of adding text and/or an image on top of a base image (e.g., image 106). The photo booth application 128 of the mobile device 116 may automatically affix a custom photo frame overlay image 208 on the image 106 that is being displayed on the transparent touch display 102 based on user 314 preferences (eg., event theme, color scheme, etc.), according to one embodiment.

The filter module 210 may be a set of standardized template program and/or units to provide a comprehensive collection of filters for enhancing both image 106 and/or curve data. The filter module 210 may help modify and/or enhance photograph and/or video taken by the front facing camera 118 of the mobile device 116 and displayed on the transparent touch display 102 as an image 106. For example, the filter module 210 may be used to apply filter to an image 106 to emphasize certain features and/or remove other features. Image processing operations implemented using the filter module 210 may include smoothing, sharpening, and edge enhancement of the image 106, according to one embodiment.

The visual filter effect 212 may be a process of modifying and/or enhancing an image 106 by applying a pre-made template for adjusting the contrast, color balance, and other aesthetic settings of a digital image 106. Instead of manually adjusting these aspects, a filter can be applied to quickly achieve the desired effect. The visual filter effect 212 may be a graphical operation that is applied to an element as it is drawn into the document. It may be an image-based effect, in that it takes zero and/or more images (e.g., using the set of visual filters 304) as input, a number of parameters specific to the effect, and then produces an image 106 as output, according to one embodiment.

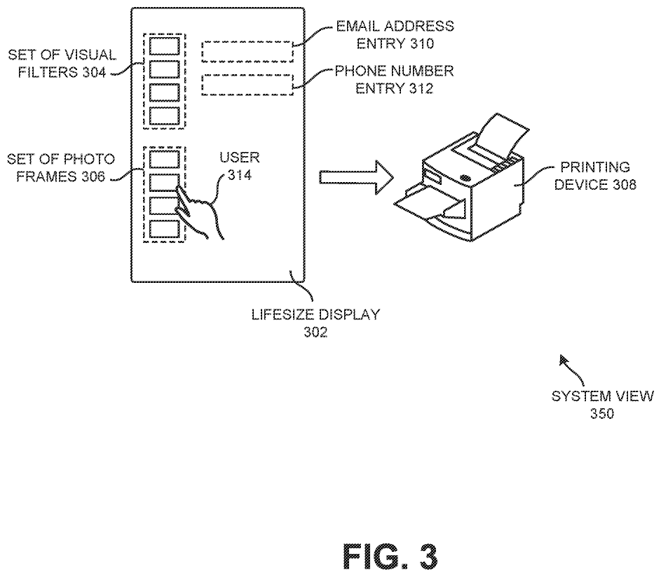

FIG. 3 is a conceptual view 350 of the photo booth system 150 of FIG. 1 illustrating an automatic printing of a copy of the image 106 when a printing operation 206 is initiated on the photo booth application 128 using the transparent touch screen display 102, according to one embodiment. Particularly, FIG. 3 builds on FIG. 1 and FIG. 2, and further adds, a lifesize display 302, a set of visual filters 304, a set of photo frames 306, a printing device 308, an email address entry 310, and phone number entry 312, according to one embodiment.

The lifesize display 302 may be a device with a full size screen of the photo booth system 150 that shows a rendered electronic image (e.g., image 106) made up of pixels that are illuminated in a way that distinguishes text and graphic elements. The lifesize display 302 may function as a transparent touch screen display 102 of the photo booth system 150. The lifesize display 302 may have the capability to function as a touch-enabled, transparent screen within the photo booth system 150, according to one embodiment.

This may mean that the user 314 interacting with the transparent touch display 102 and/or lifesize display 302 of the photo booth system 150 may directly touch and interact with the display, which is transparent, allowing him/her to see both the content displayed on the transparent touch display 102 and their own reflections and/or the environment behind the screen. The touch functionality may enable the user 314 to interact with the photo booth system 150, possibly for activities such as selecting options (e.g., using operation 206), navigating menus, and/or capturing photos (e.g., view 202), according to one embodiment.

The set of visual filters 304 may be a collection of pre-made templates for adjusting the contrast, color balance, and other aesthetic settings of a digital photo (e.g., image 106). Instead of manually adjusting these aspects, a filter from the set of visual filters 304 may be applied to quickly achieve the desired effect. The use of filter from the set of visual filters 304 may allow changing the appearance of the image 106 by altering the colors of the pixels, such as increasing the contrast as well as adding a variety of special effects to images 106 may be some of the results of applying filters, according to one embodiment.

The set of photo frames 306 may be a collection of pre-made templates of decorative edge line that borders the perimeter of the image 106 and/or photograph for visual appreciation. The printing device 308 may be an external hardware output device that takes the electronic data stored in a computer and/or other device and generates a hard copy. The printing device 308 may generate a hard copy of the image captured by the front facing camera 118 of the mobile device 116 and presented on the lifesize display 302. In another embodiment, the printing device 308 may automatically print a copy of the image when a print operation is initiated on the photo booth application 128 installed in the mobile device 116 using the transparent touch screen display 102, according to one embodiment.

The email address entry 310 may be the option of entering the electronic address of the user 114 to enable communication with the photo booth system 150. The phone number entry 312 may be the option of entering the contact number of the user 114 to enable communication with the photo booth system 150, according to one embodiment.

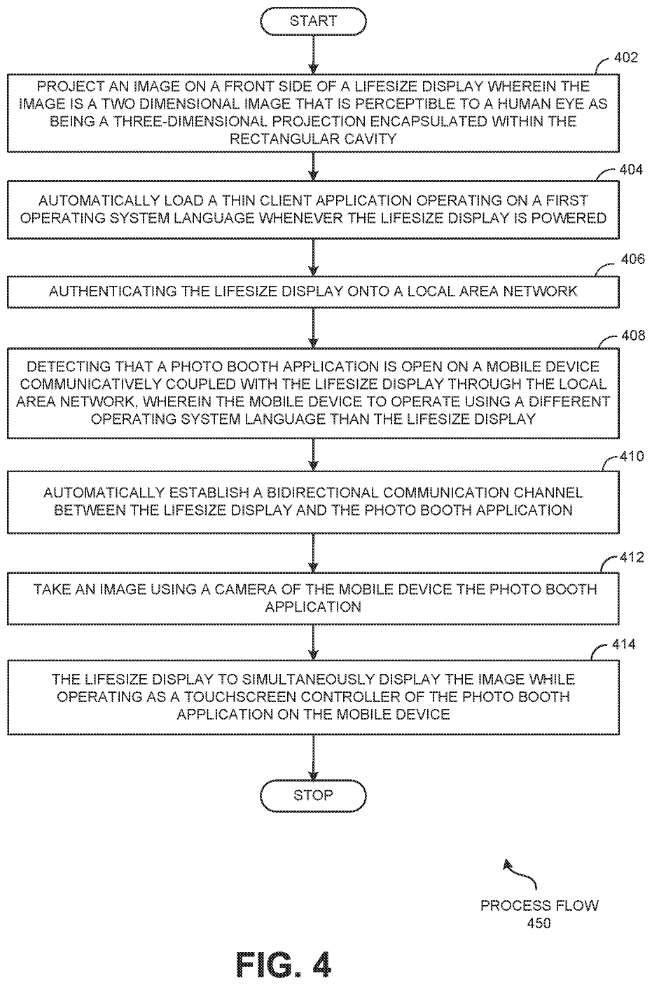

FIG. 4 is a process flow 450 detailing the operations involved in taking an interactive photograph at a live event through a wirelessly coupled photobooth touchscreen display with a mobile device 116 of FIG. 1, according to one embodiment.

In operation 402, the method may project an image 106 on a front side of a lifesize display (e.g., transparent touch display 102). The image 106 may be a two dimensional image that is perceptible to a human eye as being a three dimensional projection encapsulated within the rectangular cavity 104, according to one embodiment.

In operation 404, the method may automatically load a thin client application 112 operating on a first operating system 110 language whenever the lifesize display (e.g., transparent touch display 102) is powered. In operation 406, the method may authenticate the lifesize display (e.g., transparent touch display 102) onto a local area network 114, according to one embodiment.

In operation 408, the method may detect that a photo booth application 128 is open on a mobile device 116 communicatively coupled with the lifesize display (e.g., transparent touch display 102) through the local area network 114. The mobile device 116 may operate using a different operating system 120 language than the lifesize display (e.g., transparent touch display 102). In operation 410, the method may automatically establish a bidirectional communication channel between the lifesize display (e.g., transparent touch display 102) and the photo booth application 128, according to one embodiment.

In operation 412, the photo booth application 128 may take an image 106 using a camera (e.g., front facing camera 118) of the mobile device 116. In operation 414, the lifesize display (e.g., transparent touch display 102) may simultaneously display the image 106 while operating as a touchscreen controller 204 of the photo booth application 128 on the mobile device 116, according to one embodiment.

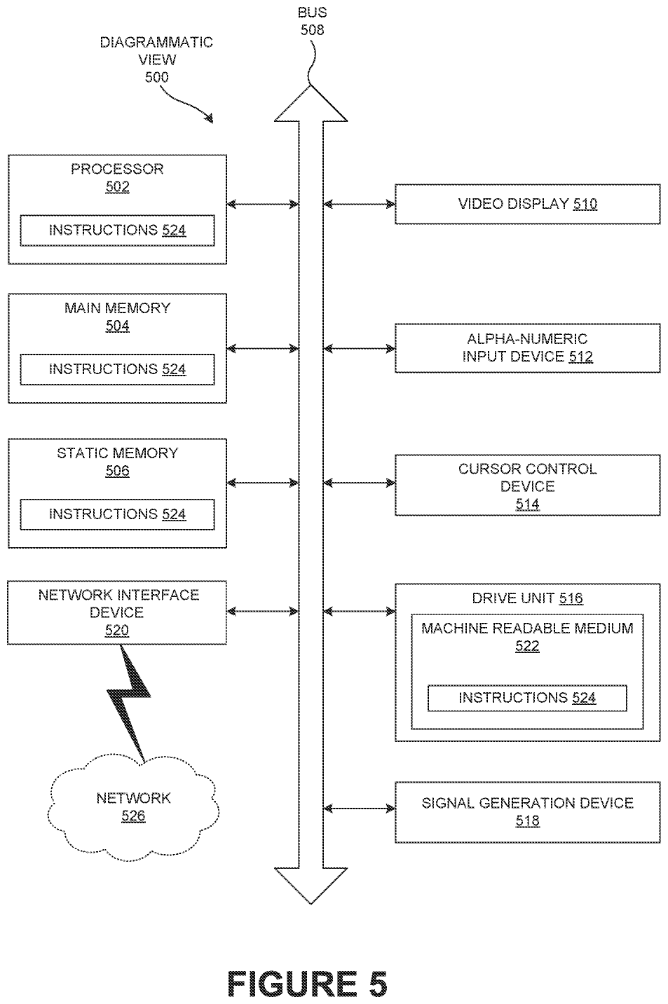

FIG. 5 is a diagrammatic system view, according to one embodiment. FIG. 5 is a diagrammatic system view 500 of a data processing system (e.g., a desktop computer, a laptop, mobile device 116, transparent touch display 102, etc.) in which any of the embodiments disclosed herein may be performed, according to one embodiment. Particularly, the system view 500 of FIG. 5 illustrates a processor 502, a main memory 504, a static memory 506, a bus 508, a video display 510, an alpha-numeric input device 512, a cursor control device 514, a drive unit 516, a signal generation device 518, a network interface device 520, a machine readable medium 522, instructions 524, and a network 526, according to one embodiment.

The diagrammatic system view 500 may indicate a personal computer and/or a data processing system (e.g., a desktop computer, a laptop, mobile device 116, etc.) in which one or more operations disclosed herein are performed. The processor 502 may be in congruous to the processor 130 of the transparent touch display 102. The processor 502 may be microprocessor, a state machine, an application specific integrated circuit, a field programmable gate array, etc. (e.g., Intel® Pentium® processor). The main memory 504 may be a dynamic random access memory and/or a primary memory of a computer system.

The static memory 506 may be a hard drive, a flash drive, and/or other memory information associated with the data processing system (e.g., a desktop computer, a laptop, mobile device 116, transparent touch display 102, etc.). The bus 508 may be an interconnection between various circuits and/or structures of the data processing system (e.g., a desktop computer, a laptop, mobile device 116, transparent touch display 102, etc.). The video display 510 may provide graphical representation of information on the data processing (e.g., a desktop computer, a laptop, mobile device 116, transparent touch display 102, etc.). The alpha-numeric input device 512 may be a keypad, keyboard and/or any other input device of text (e.g., a special device to aid the physically handicapped). The cursor control device 514 may be a pointing device such as a mouse.

The network interface device (NID) 520 may be a hardware device that serves as the demarcation point between a telecommunications service provider's network 526 and a customer's premises. The network interface device 520 may provide a physical connection and termination point for the communication lines that deliver services to a customer's (e.g., user's) location.

The drive unit 516 may be a hard drive, a storage system, and/or other longer term storage subsystem. The signal generation device 518 may be a bios and/or a functional operating system of the data processing system (e.g., a desktop computer, a laptop, mobile device 116, etc.). The machine readable medium 522 may provide instructions on which any of the methods disclosed herein may be performed. The instructions 524 may provide source code and/or data code to the processor 502 to enable any one/or more operations disclosed herein.

In various embodiments as described in FIGS. 1-5, interoperability between Android and

iOS applications are overcome despite differences underlying platforms and technologies. Some of the technical challenges that the various embodiments described in FIGS. 1-5 overcome include: Programming Languages: Android applications are typically developed using Java or Kotlin, while iOS applications are developed using Swift or Objective-C. The difference in programming languages required the embodiments described in FIGS. 1-5 to rewrite or adapt the codebase for each platform while still ensuring code reuse and interoperability through the described techniques. User interface differences between Android and iOS been reconciled thanks to the embodiments described in FIGS. 1-5. The user interface components, layout, and navigation patterns vary between the two platforms but through the techniques described various embodiments of FIGS. 1-5, no separate UI implementations for each platform or building of a custom UI abstraction layer is required. Through the interoperable mirroring techniques of FIGS. 1-5, Android and iOS provide their own set of platform-specific APIs for accessing device features, such as camera, sensors, contacts, and location services. These APIs have different programming interfaces, behavior, and capabilities, but through the embodiments of FIGS. 1-5, challenges to achieve consistent functionality across platforms are overcome. Embodiments of FIGS. 1-5 applications minimize reliance on third-party libraries and software development kits (SDKs) to add functionality or integrate with external services without costly programmatic changes.

In addition, embodiments of FIGS. 1-5 minimize the need to modify security and permissions changes despite Android and iOS have different security models and permission systems. Android uses a more open approach with granular permissions, while iOS follows a more restrictive model. Ensuring consistent security through Embodiments of FIGS. 1-5 measures and handles permissions consistently through the interoperable applications described herein.

Embodiments of FIGS. 1-5 enable seamless backend integration because the embodiments enable a common backend or server infrastructure, ensuring seamless integration without extensive effort. The backend services need not handle requests from different platforms, handle platform-specific data formats, and maintain data consistency across platforms thanks to embodiments of FIGS. 1-5.

Embodiments of FIGS. 1-5 ensure testing and quality assurance through interoperability. No separate testing, and additional effort is needed to ensure that features and functionalities work consistently across Android and iOS thanks to the thanks to embodiments of FIGS. 1-5.

An example embodiment will now be described. Jane Doe may be a small-time event organizer based in NY. Jane may be organizing small events for private parties and/or get together for social and/or commercial activities. Jane Doe may have a photo booth installed in her events to enable individuals and/or groups to take photos of themselves at these events and/or parties at private and/or public places. Jane Doc's customers may want to get input from their friends when customizing their photos. However, a display of the photo booth on which the customers can customize screens may be small and limited in its options, making it difficult to customize and share. Therefore, the photo booth experience may not capture the input of her customer's friends and family near a photo booth prior to a photo being printed and/or shared. In addition, Jane's photo booth may be a small, self-contained setup. Finally, there may be technical problems that prevent the photo booth from reliably operating when in a mixed operating system environment. These issues may have disrupted the Jane's customer experience and lead to frustration among her event attendees, leaving her events irritably.

To make her clients enjoy her events and make cheerful memories, Jane may now have installed the new photo booth system 150 as described in various embodiments of FIGS. 1 to 5. As described in the various embodiments of FIGS. 1 to 5, Jane's customer's may now be able to easily pair their mobile device 116 with the new photo booth system 150 using the local area network 114 to capture their photographs. The operating systems of Jane's new photo booth system 150 may be compatible with different operating systems used in the mobile device 116 making it easy for her customer's to pair their devices with the new photo booth system 150.

Jane's customer's may now be able to instantly get input from their friends and loved ones by sharing those photographs and customize those based on their preferences and choices using the new photo booth system 150 as described in various embodiments of FIGS. 1 to 5, before sharing or posting them in the social media platforms, thereby creating positive and lasting memories of the events they attended and leaving her events happily.

Although the present embodiments have been described with reference to specific example embodiments, it will be evident that various modifications and changes may be made to these embodiments without departing from the broader spirit and scope of the various embodiments.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

1. A photo booth system, comprising:
a transparent touch display to project an image on a front side of the transparent touch display;
a set of walls on a rear side of the transparent touch display to form a rectangular cavity,
wherein the image is a two dimensional image that is perceptible to a human eye as being a three dimensional projection encapsulated within the rectangular cavity;
a wireless communications circuitry associated with a processor and a memory of the transparent touch display, wherein the memory to automatically load a thin client application operating on a first operating system language whenever the transparent touch display is powered, and wherein the wireless communication circuitry to authenticate onto a local area network;
a mobile device having a front facing camera which operates a different operating system language than the first operating system language;
a tripod on which the mobile device is affixed;
a field of view area in which the image is captured using the mobile device, wherein the image is a portrait of at least one human subject in the field of view area; and
a photo booth application executing on the different operating system language of the mobile device to automatically establish a bidirectional communication channel with the transparent touch display.

2. The photo booth system of claim 1 wherein the transparent touch display to wirelessly mirror a view displayed on the mobile device as the image.

3. The photo booth system of claim 2 wherein the transparent touch display to serve as a touchscreen to serve as a controller for an operation of the photo booth application on the mobile device.

4. The photo booth system of claim 3 wherein the photo booth application on the mobile device to automatically affix a custom photo frame overlay image on the image.

5. The photo booth system of claim 4 wherein the photo booth application on the mobile device to automatically apply a visual filter effect on the image.

6. The photo booth system of claim 5 wherein a user of the transparent touch display is permitted to select from any one of a set of photo frames and any one of a set of visual filters to apply to the image.

7. The photo booth system of claim 6 wherein any one of a set of photo frames and any one of a set of visual filters applied to the image are automatically viewable on the transparent touch display.

8. The photo booth system of claim 7 wherein the transparent touch display is a lifesize display that is at least 72 inches tall.

9. The photo booth system of claim 8 further comprising: a printing device to automatically print a copy of the image when a print operation is initiated on the photo booth application using the transparent touch screen display.

10. The photo booth system of claim 9 wherein the user is able to enter at least one of an email address and a phone number using the transparent touch display to which the image is communicated.

11. A photography system, comprising:
a photo booth having a transparent touch display that projects an image;
a local area network;
a mobile device to capture the image from a human subject,
wherein the transparent touch display to wirelessly serve as a controller of a photo booth application executing on the mobile device, and
wherein the transparent touch display of the photo booth and the photo booth application on the mobile device are automatically wirelessly paired with each other through the local area network using at least one of User Datagram Protocol (UDP) and a Transmission Control Protocol/Internet Protocol (TCP/IP) protocol using three ports despite the photo booth and the mobile device having different operating systems, and
wherein the first port is used to mirror the information on a screen of the mobile device onto the transparent touch display, and other two ports are used for bidirectional communication channels between the transparent touch display of the photo booth and the photo booth application of the mobile device.

12. The photo booth system of claim 11
wherein the transparent touch display to wirelessly mirror a view displayed on the mobile device as the image, and
wherein a set of walls on a rear side of the transparent touch display to form a rectangular cavity in which the image is a two dimensional image that is perceptible to a human eye as being a three dimensional projection encapsulated within the rectangular cavity.

13. The photo booth system of claim 12 wherein the transparent touch display to serve as a touchscreen to control an operation of the photo booth application on the mobile device.

14. The photo booth system of claim 13:
wherein the photo booth application on the mobile device to automatically affix a custom photo frame overlay image on the image,
wherein the photo booth application on the mobile device to automatically apply a visual filter effect on the image,
wherein a user of the transparent touch display is permitted to select from any one of a set of photo frames and any one of a set of visual filters to apply to the image, and
wherein the any one of a set of photo frames and any one of a set of visual filters applied to the image are automatically viewable on the transparent touch display.

15. A method comprising:
projecting an image on a front side of a lifesize display,
wherein the image is a two dimensional image that is perceptible to a human eye as being a three dimensional projection encapsulated within the rectangular cavity;
automatically loading a thin client application operating on a first operating system language whenever the lifesize display is powered;
authenticating the lifesize display onto a local area network;
detecting that a photo booth application is open on a mobile device communicatively coupled with the lifesize display through the local area network, wherein the mobile device to operate using a different operating system language than the lifesize display; and
automatically establishing a bidirectional communication channel between the lifesize display and the photo booth application,
wherein the photo booth application to take an image using a camera of the mobile device, and
wherein the lifesize display to simultaneously display the image while operating as a touchscreen controller of the photo booth application on the mobile device.

16. The method system of claim 15 further comprising: wirelessly mirroring a view displayed on the mobile device.

17. The method system of claim 15 further comprising automatically affixing a custom photo frame overlay image on the image, wherein the image is a two dimensional image that is perceptible to a human eye as being a three dimensional projection encapsulated within a rectangular cavity formed by a set of walls on rear side of the lifesize display and the lifesize display is a transparent touchscreen display.

18. The photo booth system of claim 15 further comprising: automatically applying a visual filter effect on the image.

19. The photo booth system of claim 18 further comprising permitting a user of the lifesize display to select from any one of a set of photo frames and any one of a set of visual filters to apply to the image.

20. The photo booth system of claim 6 wherein any one of a set of photo frames and any one of a set of visual filters applied to the image are automatically viewable on the transparent touch display.
